(19) United States
(12) Patent Application Publication
(10) Pub. No.: US 2005/0219953 A1
(43) Pub. Date: Oct. 6, 2005

(54) Method and system for operating capacitive membrane ultrasonic transducers

(75) Inventors: Baris Bayram, Stanford, CA (US); Edward Haeggstrom, Helsinki (FI); Goksen Yaralioglu, Mountain View, CA (US); Butrus T. Khuri-Yakub, Palo Alto, CA (US)

Correspondence Address: DORSEY & WHITNEY LLP, 555 CALIFORNIA STREET, SUITE 1000, SUITE 1000, SAN FRANCISCO, CA, 94104, US

(73) Assignee: The Board of Trustees of the Leland Stanford Junior University

(21) Appl. No.: 11/078,795

(22) Filed: Mar. 10, 2005

Related U.S. Application Data
(60) Provisional application No. 60/560,333, filed on Apr. 6, 2004.
(60) Provisional application No. 60/615,319, filed on Sep. 30, 2004.

(51) Int. Cl. H04B 1/02

(52) U.S. Cl. 367/178; 367/137

(57) ABSTRACT

A capacitive membrane ultrasonic transducer system and method of operation is described. The transducers are operated in the collapsed mode. In this mode the membrane is first subjected to a voltage higher than the collapse voltage, therefore initially collapsing the membrane onto the substrate. Then, a bias voltage is applied having an amplitude between the collapse and snapback voltages. At this bias voltage, the center of the membrane still contacts the substrate. By applying driving AC voltage or voltage pulses harmonic membrane motion is obtained in a circular ring concentric to the center. In this regime, between collapse and snapback, the cMUT has a higher eletromechanical coupling efficiency than it has when it is operated in the conventional pre-collapse mode.

### CROSS-REFERENCES TO RELATED APPLICATIONS

This application claims priority to U.S. Provisional Patent Application No. 60/560,333 filed Apr. 6, 2004 and U.S. Provisional Patent Application No. 60/615,319 filed Sep. 30, 2004.

### BRIEF DESCRIPTION OF THE INVENTION

This invention relates generally to micro-electro-mechanical systems (MEMS) and particularly to capacitive membrane ultrasonic transducers, and describes a novel method and system for their operation in collapsed mode.

### BACKGROUND OF THE INVENTION

Capacitive membrane ultrasonic transducers have a metal coated membrane such as silicon or silicon nitride supported above a substrate by an insulating layer such as silicon oxide, silicon nitride or other insulating material. The substrate may be a highly doped semiconductor material such as silicon or may be undoped silicon with a metal layer. The thin metal covering the membrane and the highly doped substrate or metal layer form the two electrodes of a capacitor. Generally the substrate, support and membrane form a cell which may be evacuated inside the gap. Generally the transducers comprise a plurality of cells of the same or different sizes and shapes. In operation, the cells may be arranged in arrays with the electrical excitation generating beam patterns. Typically transducer cells have sizes ranging between 5 μm and 1000 μm in diameter.

The fabrication and operation of capacitive membrane transducers is described in many publications and patents. For example U.S. Pat. Nos. 5,619,476, 5,870,351 and 5,894,452 incorporated herein by reference describe fabrication using surface machining technologies. Pending Application Ser. No. 60/683,057 filed Aug. 7, 2003 incorporated herein by reference describes fabrication by using wafer bonding techniques. Such transducers are herein referred to a capacitive micromachined transducers (cMUTS).

The active part of a cMUT is the metal-coated membrane. A DC bias voltage applied between the membrane and the bottom electrodes creates electrostatic attraction, pulling the membrane toward the substrate. If an AC voltage is applied to a biased membrane, harmonic membrane motion is obtained. The DC bias voltage strongly affects the AC vibrational amplitude. As the DC voltage is increased, a larger sinusoidal membrane motion and increase in transmitted acoustic pressure are obtained [1]. To achieve maximum efficiency, the conventional operation of the cMUT requires a bias voltage close to the collapse voltage, at which voltage the membrane contacts the substrate. The sum of the DC bias and the applied AC signal must not exceed the collapse voltage in the conventional operation. Therefore, total acoustic output pressure is limited by the maximum-allowed AC voltage on the membrane.

If a biased cMUT membrane is subject to an impinging ultrasonic pressure field, the membrane motion generates AC detection currents. This current amplitude increases with increasing DC bias voltage. To maximize the receive sensitivity, the bias voltage is increased close to the collapse voltage. Again, it is required that the sum of the bias voltage and the received voltage due to the motion caused by the ultrasonic pressure field be less than the collapse voltage. Therefore, it is difficult to obtain high coupling efficiency (k_{T}²) with large AC signals in transmit and reception of the ultrasonic waves. The transducer's electromechanical coupling efficiency (k_{T}²) is a crucial parameter describing the conversion efficiency of the device between the electrostatic and mechanical energy domains. This parameter, as mentioned, is a function of the bias voltage. The electromechanical coupling efficiency (k_{T}²) increases to reasonable values only when the DC bias voltage is in close vicinity of the collapse voltage. For instance, a coupling efficiency exceeding 0.5 requires a bias voltage larger than 90% of the collapse voltage, thus, limiting the maximum applicable AC signal to 10% of the collapse voltage.

### OBJECTS AND SUMMARY OF THE INVENTION

It is an object of the present invention to provide a capacitive membrane ultrasonic transducer system and method of operation having a higher electromechanical coupling efficiency than conventional prior art cMUT systems.

It is a further object of the present invention to provide a high frequency, low voltage ultrasonic transducer system.

It is a further object of the present invention to provide a transducer system having center frequency tunability as a function of the DC bias voltage.

It is a further object of the present invention to provide a transducer system and method of operation having increased frequency bandwidth.

The foregoing and other objects of the invention are achieved by operating the transducers in the collapsed operating regime. In this regime, the membrane is first biased at a voltage higher than the collapse voltage, therefore initially collapsing the membrane onto the substrate. Then, the bias is changed to a level, which is larger than the snapback voltage to ensure the collapsed membrane state. At this operating voltage, the center of the membrane still contacts the substrate. By adding an AC voltage, harmonic membrane motion is obtained in a circular ring concentric to the center. In this regime, the ultrasonic transducer has a higher electromechanical coupling efficiency than it has when it is operated in the conventional pre-collapse regime.

### BRIEF DESCRIPTION OF THE DRAWINGS

The foregoing and other objects of the invention will be more clearly understood from reading the following description of the invention in conjunction with the accompanying drawings in which:

FIG. 1 shows a sectional view of a circular cMUT axisymmetric about the Y-axis;

FIG. 2 shows the membrane shape for different DC bias voltages. The conventional regime of operation is depicted ‘1’ and the new regime is depicted ‘2’;

FIG. 3 shows the bias voltage-capacitance curve of the cMUT;

FIG. 4 shows the bias voltage-coupling efficiency (k_{T}²) curve of the cMUT;

FIG. 5 shows the average and maximum membrane displacement as a function of applied voltage. The conventional region of operation is depicted ‘1’ while the new region of operation is depicted ‘2’;

FIG. 6 shows the average displacement per volt, for a 1 V AC signals, for the cMUT indicating the sensitivity of the device. The conventional region of operation is depicted ‘1’ while the new region of operation is depicted ‘2’;

FIG. 7 shows the net membrane deflection profiles in the conventional and collapsed operations using a 1 V AC signal;

FIG. 8 shows another cMUT model;

FIG. 9 shows a simplified drive circuit for cMUTs;

FIGS. 10 and 11 show voltages for operating a cMUT in accordance with the present invention;

FIG. 12 shows the average membrane displacement as a function of time for the cMUT cell of FIG. 8. The cMUT cell was biased at 70 V both in conventional and collapsed regimes. A +5 V, 20 ns rectangular pulse was applied;

FIG. 13 shows the average membrane pressure as a function of time for the cMUT cell of FIG. 8. The cMUT cell was biased at 70 V both in conventional and collapsed regimes. A +5 V, 20 ns rectangular pulse was applied;

FIG. 14 shows the peak-to-peak average displacement as a function of bias voltage in both conventional and collapsed regimes;

FIG. 15 shows the second order harmonic level as a function of peak-to-peak AC voltage in both conventional and collapsed regimes;

FIG. 16 shows a cMUT model;

FIGS. 17a and 17b show the 3-D static finite element results for the 2-D rectangular cMUT cell. a) Bias voltage-capacitance curve of the cMUT cell. b) Bias voltage-coupling efficiency (k_{T}²) curve of the cMUT cell;

FIGS. 18a, 18b, 18c and 18d show the conventional and collapsed operation regimes. The solid and dashed lines correspond to the collapsed and conventional operation regimes at 83 V bias voltage, respectively. a) Average pressure as a function of time. Acoustic output pressure is averaged over the plane 60 μm away from the cMUT surface. A +5V rectangular pulse is applied for t_{P}=20 ns at t=0.6 μs. b) The frequency spectrum of the average acoustic output pressure divided by that of the pulse. A +5V rectangular pulse is applied for t_{P}=20 ns at t=0.6 μs. c) Average pressure as a function of time. Acoustic output pressure is averaged over the plane 60 μm away from the cMUT surface. A +30V rectangular pulse is applied for t_{P}=20 ns at t=0.6 μs. d). The frequency spectrum of the average acoustic output pressure divided by that of the pulse. A +30 V rectangular pulse is applied for t_{P}=20 ns at t=0.6 μs; and

FIG. 19(a) and 19(b) shows the center frequency tunability feature of the collapsed operation. The cMUT was biased at 120 V in the collapsed operation regime. A −30V rectangular pulse is applied for t_{P}=20 ns at t=1 μs. a) Average pressure as a function of time. Acoustic output pressure is averaged over the plane 60 μm away from the cMUT surface. b) The frequency spectrum of the average acoustic output pressure divided with that of the pulse.

### DESCRIPTION OF PREFERRED EMBODIMENTS

Static finite element calculations were used to analyze the collapsed operation assuming small signal excitation. The coupling efficiency (k_{T}²), the average membrane displacement and the capacitance were calculated as a function of the bias voltage in both conventional and collapsed operations. The collapsed operation of the cMUT showed superior transmit capability and receive sensitivity compared to the conventional operation.

The static finite element calculations assumed a quasistatic situation in which the membrane could respond to an applied signal without delay. Hence dynamic effects were not taken into consideration. To better understand the collapsed operation, the dynamic analysis of an immersed single cMUT cell was performed using 2-D time-domain, coupled field (electrostatic and structural), nonlinear (contact) finite element analysis. The dynamic FEM results confirmed the predictions of the earlier static FEM results regarding higher coupling efficiency. Furthermore, the center frequency of the collapsed operation was determined to be approximately twice of the center frequency in the conventional operation. The linearity was also 10 dB better in the collapsed operation than the conventional operation.

In general, cMUTs include hundreds of cMUT cells, all driven in parallel [3]. These cMUTs show overdamped response in a fluid acoustic medium and provide broadband operation in transmit and receive of ultrasound [3]. This is a significant difference from the single cMUT cell analyzed earlier, which is underdamped and results in several ringings before coming to rest. Crosstalk between the cMUT elements was investigated in [4]. Two main sources of coupling shown in this analysis were due to Scholte wave propagating at the transducer-water interface and Lamb wave propagating in the substrate. To accurately model these coupling mechanisms, 3-D time-domain, coupled field, nonlinear, finite element analysis of an infinitely large capacitive membrane ultrasonic transducer on a substrate loaded with acoustic fluid medium was performed. The FEM results of this analysis confirmed the above-mentioned static and dynamic FEM results. Additionally, fractional bandwidth over 100% was calculated in the collapsed operation, and the loading effect of the neighboring cMUT cells was also observed in the frequency spectrum of the average pressure.

In the following sections, the FEM models and the obtained results are presented to show the features of the collapsed operation regime.

Detailed Technical Description (Static FEM Analysis)

1) FEM Model and Analysis

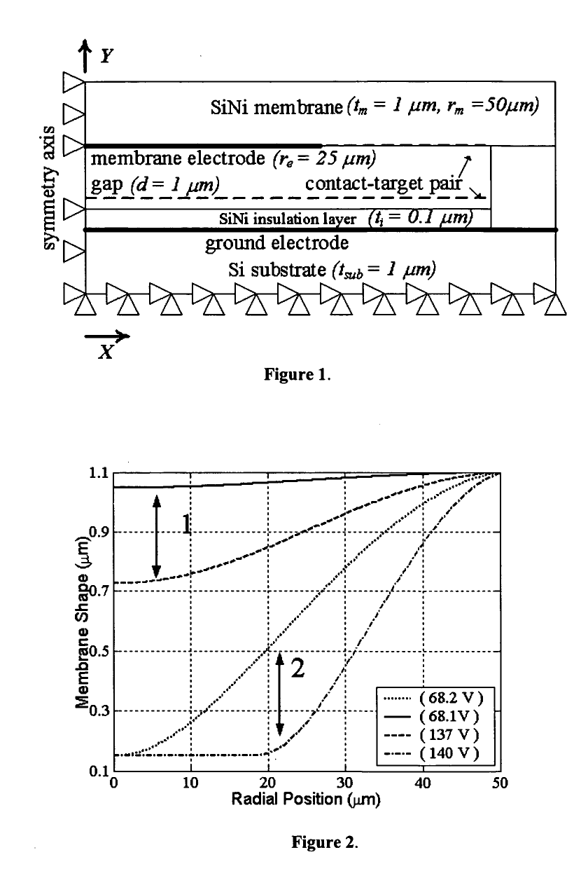

A cMUT featuring a circular silicon nitride (Si₃N₄) membrane was modeled using a commercially available FEM package (ANSYS 5.7) [5]. The FEM model of a cMUT is shown schematically in FIG. 1. The membrane was supported at its edges. There was a vacuum gap between the membrane and the substrate. A thin insulation layer of Si₃N₄ over the highly doped silicon (Si) substrate prevented shorting the grounded substrate electrode and the electrode on the bottom of the membrane at collapse. The structure was circularly symmetric allowing the use of 2D modeling. Boundary conditions are applied as shown in FIG. 1. The structure was clamped at the symmetry axis in the x-direction to prevent horizontal membrane movement, and the substrate was supported at the bottom. The ground electrode was beneath the Si₃N₄ insulation layer. The other electrode was positioned on the bottom surface of the membrane. Its radius (rₑ) was half of the membrane radius, since half-metallization was found optimal for maximum bandwidth of the cMUTs. The electrodes were assumed to be infinitesimally thick, which corresponded to 0.2 μm thick electrodes in the fabricated devices. This assumption was made because incorporating a thicker electrode only changed the apparent stiffness, not the electrostatics of the membrane.

The ANSYS standard element types, PLANE121, which featured charge and voltage variables and PLANE82, which featured displacement and force variables, were used for electrostatic and structural analyses, respectively [5]. The collapse of the membrane onto the substrate was modeled by means of contact-target pair elements (CONTA172 and TARGE169) [5]. These surface contact elements were used to detect contact between the surfaces. The surface elements were defined on the bottom surface of the membrane and slightly above the insulation layer. The offset from the insulation layer was 5% of the gap in the analysis. This offset was required to re-mesh or re-morph the mesh inside the gap when the structure was collapsed.

FEM was used to calculate the deformed membrane shape for a given bias voltage applied to the membrane electrode. The ground electrode on the substrate was assumed to be at zero potential. First, electrostatic analysis was performed to find the electrostatic forces applied on the membrane. Then, the membrane deformation due to the electrostatic forces was calculated using structural analysis.

When the bias voltage was higher than the collapse voltage, the center of the membrane, with a certain contact radius, collapsed onto the substrate. If the bias voltage was increased further, the contact radius of the collapsed membrane also increased. Since the maximum displacement was limited by the contact surfaces, the convergence criterion was based on the electrostatic energy after membrane collapse. When the bias voltage was reduced to a level above snapback, the contact radius decreased and the membrane stayed in contact with the substrate. The contact prevailed until the bias voltage was decreased below the snapback voltage. Therefore, after collapse was reached, reducing the voltage to a value between the collapse and snapback voltages kept the membrane in contact with the substrate.

The emphasis in the static FEM analysis was the calculation of the coupling efficiency (k_{T}²) in this new operation regime. Several authors have calculated the coupling efficiency of capacitive transducers [2, 6, 7]. This efficiency, k_{T}², is the ratio of the mechanical energy delivered to the load to the stored total energy in the transducer. They calculated k_{T}² for a cMUT membrane using a derivation that relied on the use of the fixed (CS) and free (CT) capacitance of the transducer. The fixed capacitance was the capacitance of the transducer at a given DC bias:
C^{S}=C(V)|ᵥ_{_{DC}}. (1)
The free capacitance was defined as:

$${C}^{T} = \frac{ⅆ Q ( V )}{ⅆ V} {{\vert}_{{V}_{DC}} = \frac{ⅆ}{ⅆ V} ( {VC}^{S} ) \vert}_{{V}_{DC}} , \qquad ( 2 )$$

and the coupling efficiency was given by

$${k}_{T}^{2} = 1 - \frac{{C}^{S}}{{C}^{T}} . \qquad ( 3 )$$

Here, FEM was used to extract the fixed capacitance of the final deflected cMUT membrane shape at given bias voltages in order to find the voltage dependence of the capacitance, (1). The variable capacitance was then calculated using (2).

The calculations were performed on a circular membrane as shown in FIG. 1. The membrane radius was 50 μm, while the gap height and the membrane thickness was 1 μm. An insulation layer of 0.1 μm was assumed.

The calculated collapse and snapback voltages for the cMUT membrane were 140V and 68V, respectively. The calculated membrane shapes for bias voltages in the vicinity of snapback and collapse voltages are depicted in FIG. 2. The arrows indicate the membrane motion (‘1’ in the conventional operation, ‘2’ in the collapsed operation).

The vertical axis of the graph shows the position of the bottom surface of the cMUT membrane at each radial distance from the center to the membrane rim. The gap height extends from 0.1 μm, which is the position of the top of the insulation layer, to 1.1 μm, which is the position of the undeflected membrane with no applied voltage. An increase in the bias voltage results in more membrane deflection. The dashed line in FIG. 2 shows the deflected membrane shape when the applied bias voltage is close to, but still smaller than, the collapse voltage. The range between the dashed line and zero displacement indicates the range of motion of the membrane in the conventional operation ‘1’.

If the applied bias voltage is larger than the collapse voltage, the membrane collapses and the dash-dot line is obtained. The membrane is in contact with the bottom electrode up to a radius of 20 μm. As the voltage is reduced, the membrane shape changes to that of the dotted line in FIG. 2 just before snapback. The contact radius is 2 mm at this instant. The region between the dash-dotted and dotted lines ‘2’ indicates the range of displacement of the deflected membrane while in collapse. To move the membrane in this new operational regime, the applied voltage can be between 68.2 and 140 V. In FIG. 2, it is seen that the membrane can deform, and thus emit sound, even if it is collapsed. In the conventional regime, ‘1’, the volumetric change (11%) is approximately half of that in the collapsed regime, ‘2’ (19%). It is apparent that considerable volume displacement can be achieved in this new operation.

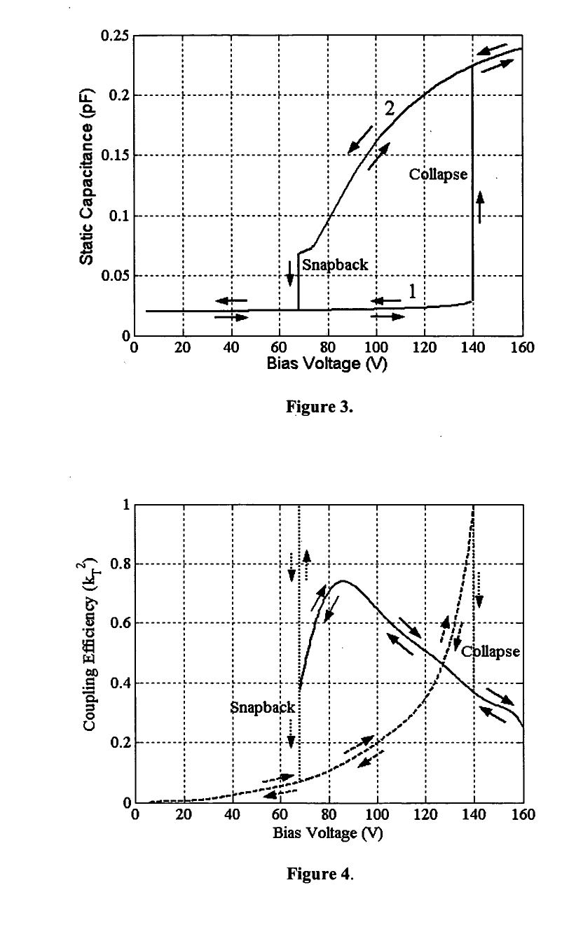

The C^{S}(V_{DC}) relationship of the cMUT is shown in FIG. 3. The initial static capacitance of 0.020 pF increases to 0.029 pF as the bias voltage is increased close to the collapse voltage. The collapse of the membrane causes an abrupt rise of the static capacitance to 0.22 pF. Subsequently lowering the bias voltage over the collapsed membrane reduces the static capacitance to 0.07 pF prior to membrane snapback. The static capacitance drops to 0.021 pF when the membrane snaps back. In the conventional operation, the capacitance change with applied voltage is relatively small. In the new regime, both the static capacitance (ordinate) and the variation in the static capacitance (slope of the static capacitance curve) increase.

The electromechanical coupling efficiency (k_{T}²) can be calculated using (3). The k_{T}²(V_{DC}) relationship of the cMUT is given in FIG. 4. The dashed curve is obtained before the membrane collapse. As the bias voltage is increased to collapse voltage, the coupling efficiency k_{T}² increases monotonically to 1. However, a k_{T}² in excess of 0.35 is obtainable only when the bias voltage exceeds 85% of the collapse voltage. If the bias voltage is increased to the collapse voltage, k_{T}² abruptly changes back to 0.35. Further increasing the bias voltage reduces k_{T}² linearly with increased bias voltage. Decreasing the bias voltage after collapsing the membrane, increases k_{T}² up to 0.7 at a bias voltage 60% of the collapse voltage. Further, decreasing the bias voltage gradually decreases k_{T}² to 0.4 before snapback occurs. Here the electromechanical coupling efficiency k_{T}² goes to 1 at the instant when the state transition takes place and then reduces to 0.07 in the trace of the curve representing the conventional operation. Thus a k_{T}² larger than 0.35 is achieved between collapse and snapback voltages, with a peak value around 0.7 at a bias voltage measuring 60% of the collapse voltage.

In FIG. 4, high k_{T}² values are achieved with a bias voltage smaller than the collapse voltage. This makes it possible to use large AC signals with no risk of collapse. Additionally, changes in the bias voltage change the k_{T}² value only slightly thus making the output power more predictable. When V_{DC} is 75-105 V, k_{T}² is 0.6-0.75. It is also important to notice that in order to obtain k_{T}² values above those obtained in region ‘2’ the AC signal is limited to 5% of the collapse voltage in the conventional regime. Moreover, the average k_{T}² value for a large AC signal (100±30 V) is 0.3 in region ‘1’ and 0.6 in regime ‘2’. This constitutes an increase of 100%, which is advantageous, both when the cMUT is used both as a receiver and as a transmitter.

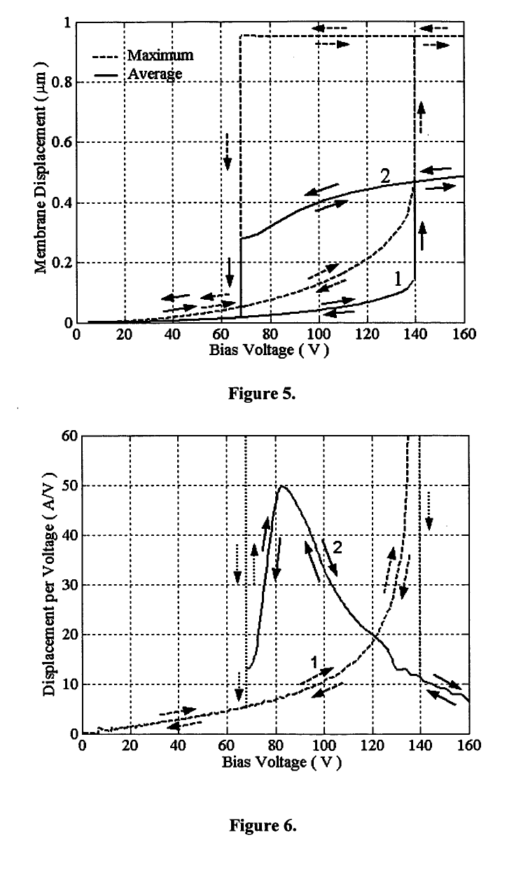

Bias voltage versus average and maximum membrane displacements are shown in FIG. 5. Maximum membrane displacement refers to the displacement of the center of the membrane. Average membrane displacement gives the displacement of an equivalent piston transducer. The average displacement is obtained by averaging the displacement of the FEM elements over the membrane surface. The conventional region of operation is depicted ‘1’ and the new region of operation is depicted ‘2’. At 100 V DC the average displacement is 0.4 μm in region ‘2’ compared to 0.15 μm in region ‘1’. The change in average displacement in region ‘2’ is 0.19 μm between DC voltages from 68 V to 140 V while the change in average displacement in region ‘1’ is 0.11 μm. This translates into a four times larger output power which is of benefit when the cMUT operates as a transmitter.

The voltage derivative of the average membrane displacement, shown in FIG. 6, gives the displacement per volt curve, i.e., the output displacement (transmitter) capability of the transducer. A maximum displacement of 50 Å/V_{AC}, is obtained at 86 V_{DC}. For V_{DC} values between 78 V and 95 V the output displacement is larger than 40 Å/V. A larger displacement (50 Å/V) and increased output power (˜displacement²) is obtained while operating in the new proposed regime, as compared to the conventional regime (10 Å/V at the same bias voltage). It is seen from FIGS. 5 and 6 that a high k_{T}² also corresponds to a large displacement of the moving membrane. The local maximum of this small-signal curve indicates a preferable point of operation providing large displacement with no risk of snapback. This point of operation gives a displacement corresponding to that obtained by operating at a bias voltage that is larger than 95% of the collapse voltage. By applying 1 V AC and 86 V DC voltages in the collapsed operation, 50 Å average displacement is achieved while by applying 1V AC and 130 V DC voltages in the conventional operation, only 30 Å average displacement is achieved. Therefore, the collapsed operation increases sensitivity (displacement/V_{AC}) and transmit pressure in comparison to the conventional operation.

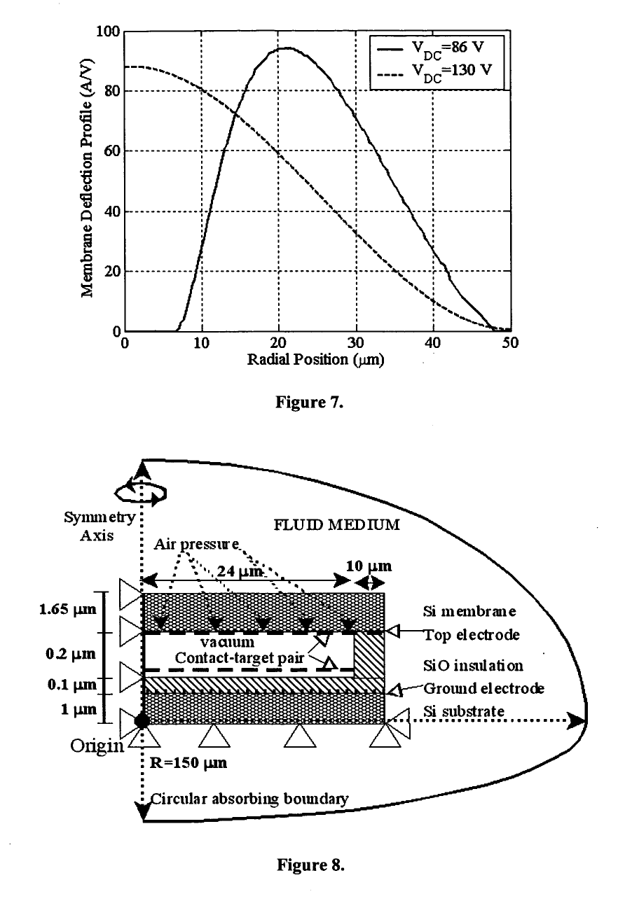

The net membrane deflection profiles in the conventional and collapsed operations are shown in FIG. 7. In the conventional operation, a DC bias of 130 V and an AC signal of 1 V cause the membrane displacement profile shown with the dashed line. A peak displacement of 90 Å is obtained in the center of the membrane. The displacement gradually reduces to zero at membrane edge. In the collapsed operation, a DC bias of 86 V (k_{T}²=0.75, cfr. FIG. 4.) and an AC signal of 1 V cause the membrane displacement profile shown with the solid line. The displacement is zero at the center and at the membrane edge, but has a peak displacement of 95 Å, cfr. FIG. 5, at approximately one-half of the membrane radius. Therefore, the mode shape of the membrane changes from the first mode of the circle in the conventional operation to the first mode of a ring in the collapsed operation.

In summary, the FEM results indicate that operating the cMUT in the new regime both in transmit and receive modes is beneficial. The results indicate that a significant increase in sensitivity, peak output pressure, and total acoustic energy transmitted is achieved in the collapsed operation compared to the conventional operation.

Detailed Technical Description (Dynamic FEM Analysis of a Single cMUT Cell)

1) FEM Model and Analysis

Finite element methods (FEM) were used to analyze the cMUT using a commercially available FEM package (ANSYS 7.1, ANSYS Inc., Canonsburg, Pa.). The FEM model of an immersed single cMUT cell is shown in FIG. 8. The structure was axisymmetric allowing 2D modeling. A conductive silicon substrate, covered with 0.1 μm silicon oxide insulation layer, was separated by a 0.2 μm vacuum gap from the 1.65 μm thick conductive silicon membrane, which was supported on the outer circular silicon oxide post. The radius of the circular membrane was 24 μm and the center frequency of the undeflected membrane was 5 MHz in water. This cMUT design featured collapse and snapback voltages of 80 V and 50 V, respectively. The bottom of the substrate was clamped and the center of the cMUT was guided along the y-axis. An air pressure of 1 atm was applied onto the membrane to model the vacuum in the gap beneath the membrane. The interface between the silicon substrate and the silicon oxide insulation layer formed the ground electrode. The top electrode was placed on the bottom of the silicon membrane. For the modeling of the membrane, the substrate and the gap, two element types PLANE42 and PLANE 121 were used as structural and electrostatic elements, respectively. The collapse of the membrane onto the substrate was modeled by means of contact-target pair elements (CONTA172 and TARGE169). The contact and target pairs were defined on the bottom of the membrane and slightly above the top of the insulation layer. This offset, required to remorph or remesh the gap for the deformed membrane, was 2% of the gap. The FLUID29 element was used to model the fluid medium covering the transducer. An absorbing boundary condition was applied on the circular boundary surrounding the fluid medium. In order to truncate the infinite immersion domain to a finite size model, an exact absorbing boundary equation was implemented. It was observed that the boundary did not cause significant spurious reflections.

Prior to the dynamic analysis, the cMUT cell was statically biased at a voltage in the conventional or collapsed operation regime. A pulse was subsequently applied to determine the output pressure and the center frequency. A sinusoidal (AC) voltage was applied to determine the generation of harmonics by the cMUT.

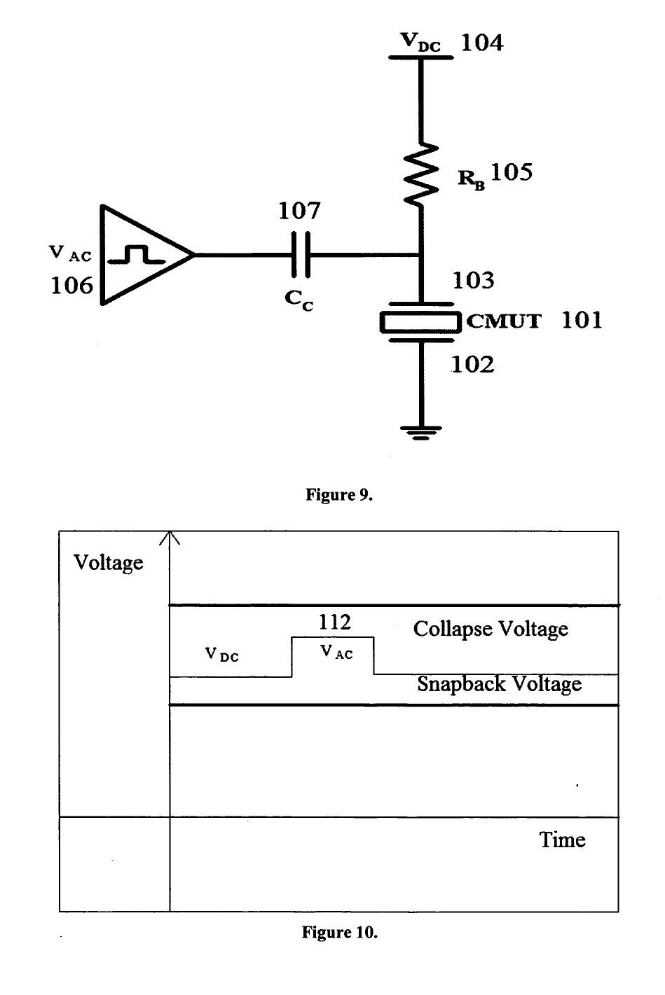

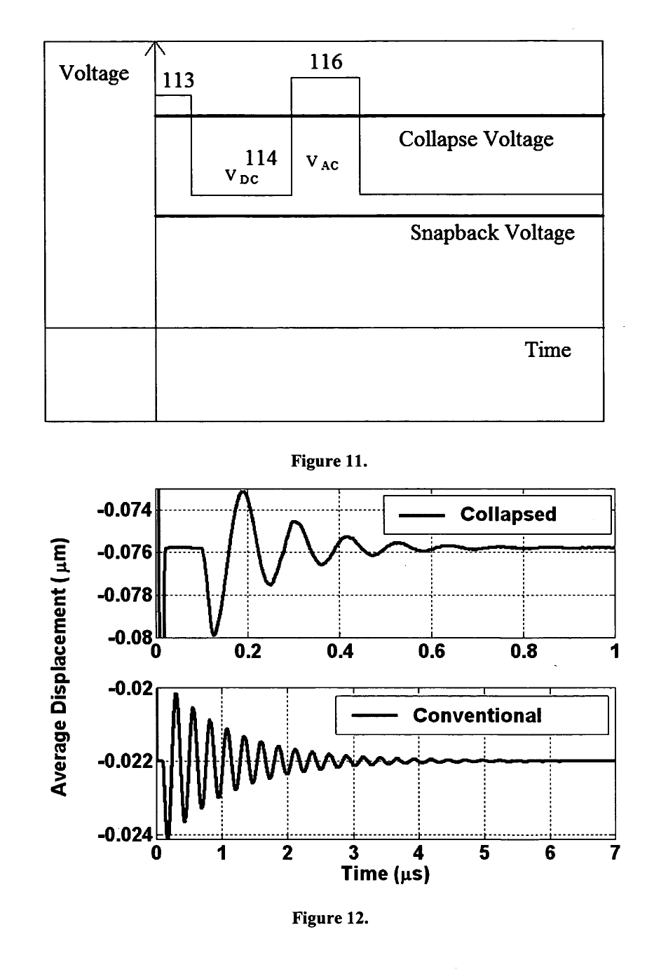

The cMUT cell was connected to a drive circuit which provided the bias voltages and the drive voltages. Referring to FIG. 9 the cMUT 101 had its substrate 102 at ground potential. The membrane electrode 103 was connected to a DC voltage source 104 through a resistor 105. The drive voltage source 106 was connected to the membrane electrode via a blocking capacitor 107. In the collapsed mode of operation the DC voltage source first delivers a voltage which collapses the membrane and then a voltage between the collapse and snapback voltage-during operation in the collapsed mode. In the conventional mode of operation the DC voltage source delivers a voltage which is less than the collapsed voltage. Referring to FIG. 10 the DC bias voltage for normal operation is shown at a value less than the collapse voltage. The drive pulse 112 is selected so that it does not drive the membrane into collapse. In FIG. 11 the DC voltage is first higher than the collapse voltage 113 and then redirected to a value between the collapse and snapback voltage 114. The drive pulse 116 is applied with a value such that its amplitude does not drive the voltage below the snapback voltage.

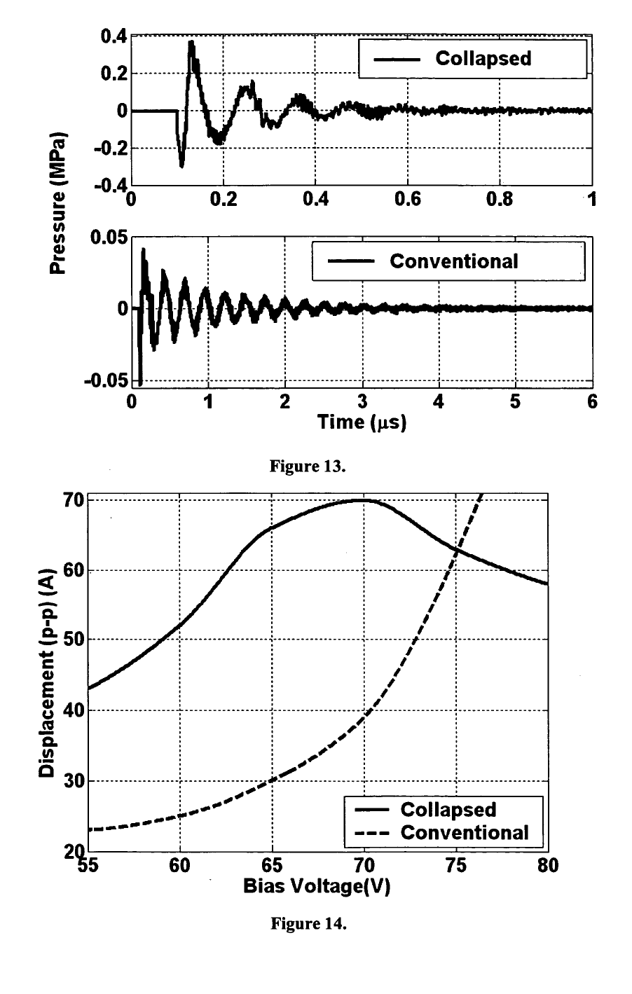

The cMUT cell was biased at 70 V DC which was lower than the collapse voltage but higher than the snapback voltage both in conventional and collapsed regimes. A +5 V, 20 ns rectangular pulse was then applied and the time waveforms of the average displacement and pressure across the membrane surface were recorded. The average displacement and pressure are shown in FIGS. 12-13. Peak-to-peak displacements (p-p) of 70 Å and 39 Å were calculated in collapsed and conventional regimes, respectively. The center frequencies were 8.7 MHz in the collapsed regime and 3.8 MHz in the conventional regime. When the bias voltage was changed between the collapse and snapback voltages, the average displacement varied as depicted in FIG. 14. The average membrane displacement in the conventional regime increased with bias voltage whereas the average membrane displacement in the collapsed regime made a peak at 70 V bias. The average displacement was significantly higher in the collapsed operation than the conventional operation.

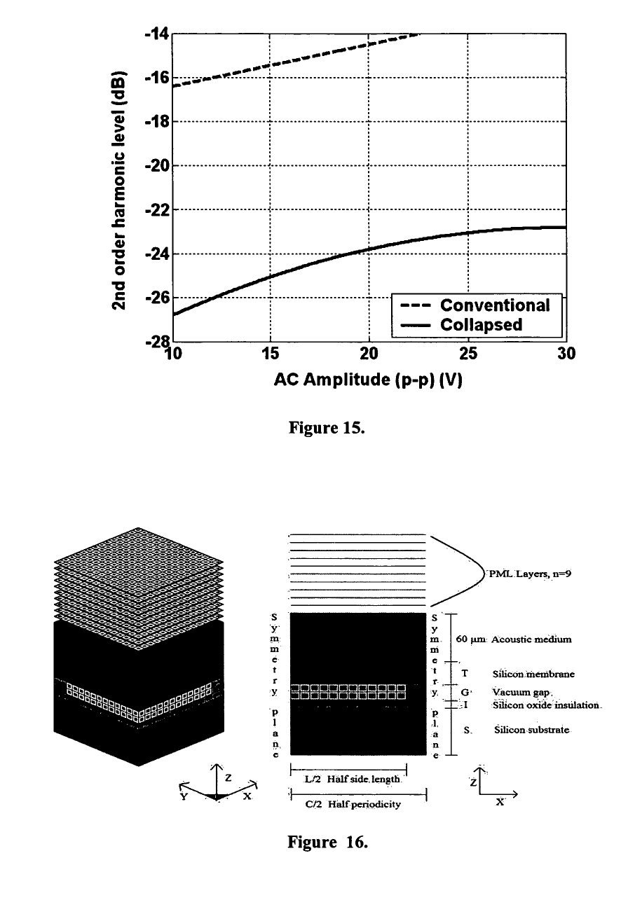

In the linearity tests, the cMUT cell was biased at 65 V in both conventional and collapsed regimes. A sinusoidal voltage (1 MHz) was applied to determine the 2nd harmonic generation as a function of the AC amplitude (FIG. 15). The collapsed regime showed a 2nd harmonic of −26 dB compared to −16 dB in the conventional regime at 5 V AC excitation. Increasing the AC amplitude decreased the linearity of the CMUT in both regimes of operation, but the linearity was still 10 dB better for large AC excitations in the collapsed operation than the conventional operation.

In summary, the collapsed operation regime offered the advantages of designing cMUTs with higher acoustic output pressure, higher center frequency and higher linearity than the conventional operation. The required bias voltage was smaller in the collapsed operation than the conventional operation. Including dynamic effects in the FEM calculations verified the quasistatic approach used in the previous static FEM calculations. The collapsed regime was successfully operated applying large AC voltages on biased membranes with no risk of collapse and snapback in the dynamic FEM analysis.

For example, assuming a cMUT designs to have a collapse voltage of 100 V DC and a snapback voltage of 6 V DC and biased at 80 V DC after applying a voltage greater than the collapse voltage say 120 V DC. The cMUT can now be operated by applying +20 V, +40 V, +60 V pulses or AC voltages having a peak amplitude less than −20 V.

Detailed Technical Description (Dynamic FEM Analysis of an Infinitely Large cMUT)

1) FEM Model and Analysis

A capacitive membrane ultrasonic transducer consists of many cMUT cells. These cells, in general, can be of various shapes such as circular, square or hexagonal. The unit cell is used as the building block of the cMUT by periodic replication on the surface. In this FEM analysis, a square membrane shape was used as the unit cell to cover the transducer area. The silicon membrane was supported on the edges with silicon oxide posts. There was a vacuum gap between the membrane and the substrate. A thin insulation layer of silicon oxide over the highly doped silicon substrate prevented shorting the ground electrode and the electrode on the bottom of the membrane in collapse. The ground electrode on the substrate was assumed to be at zero potential. The membrane was loaded with water.

Finite element methods (FEM) were used to analyze the cMUT using a commercially available FEM package (LS-DYNA) [17]. LS-DYNA is a commercially available general-purpose dynamic FEM package, capable of accurately solving complex real world problems: fast and accurate, LS-DYNA was chosen by NASA for the landing simulation of space probe Mars Pathfinder [10]. The public domain code that originated from DYNA3D, developed primarily for military and defense applications at the Lawrence Livermore National Laboratory, LS-DYNA includes advanced features, which were used in this FEM analysis: nonlinear dynamics, fluid-structure interactions, real-time acoustics, contact algorithms, and user-defined functions supported by the explicit time domain solver [10]. This powerful, dynamic FEM package was modified for the accurate characterization of ultrasonic transducers on the substrate loaded with acoustic fluid medium.

In another example a cMUT was designed for finite element analysis. The details of the finite element analysis can be found in [11] for a 2-D axisymmetric model. That analysis was modified for a square membrane in 3-D geometry. The cMUT was biased either in collapse or out of collapse, and a rectangular pulse was applied for conventional and collapsed operations. The performances of these regimes are compared in terms of the acoustic output pressure on the cMUT surface (z=60 μm away from the membrane) and the fractional bandwidth.

In designing this cMUT, the following design considerations were imposed: (1) The collapse and snapback voltages should be less than 100 V; (2) The collapse and snapback voltages should be as much apart as possible; (3) The fundamental frequency of the unbiased cMUT cell should be around 10 MHz in immersion. This cMUT model was developed for transducers fabricated with wafer-bonding technology. The residual stress in the membrane and the effect of air pressure on the membrane were not included. The physical dimensions of the cMUT shown in FIG. 16 are given in Table I.

TABLE I
PHYSICAL DIMENSIONS OF THE CMUT

| | |
|---|---|
| Side length (L) (μm) | 30 |
| Membrane thickness (T) (μm) | 1.2 |
| Gap thickness (G) (μm) | 0.18 |
| Insulating layer thickness (I) (μm) | 0.10 |
| Cell periodicity (C) (μm) | 35 |
| Substrate (S) (μm) | 500 |

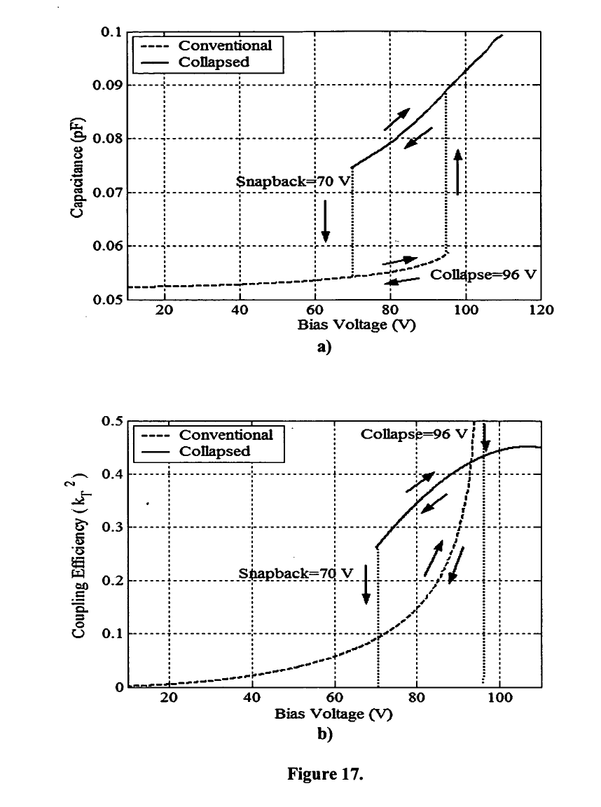

The 3-D static finite element results are given in FIG. 17. The calculated collapse and snapback voltages for the cMUT membrane were 96V and 70V, respectively. The voltage-capacitance relationship of the cMUT cell is shown in FIG. 17(a). The initial static capacitance of 52 fF increased to 59 fF as the bias voltage was increased and came close to the collapse voltage. The collapse of the membrane caused an abrupt rise of the static capacitance to 89 fF. Subsequently, lowering the bias voltage over the collapsed membrane reduced the static capacitance to 74 fF, prior to membrane snapback. The static capacitance changed to 54 fF when the membrane snapped back. The voltage-electromechanical coupling efficiency (k_{T}²) relationship of the cMUT is given in FIG. 17(b). The dashed curve was obtained before the membrane collapsed. The coupling efficiency (k_{T}²) increased monotonically to 1.0 as the bias voltage was increased to collapse voltage. However, a k_{T}² in excess of 0.30 was achieved only when the bias voltage exceeded 95% of the collapse voltage. If the bias voltage was increased to the collapse voltage, k_{T}² abruptly changed to 0.43. Further increasing the bias voltage slightly increased k_{T}² up to 0.46 at a bias voltage of 110% of the collapse voltage. Decreasing the bias voltage after collapsing the membrane decreased k_{T}² to 0.26 before snapback occurred.

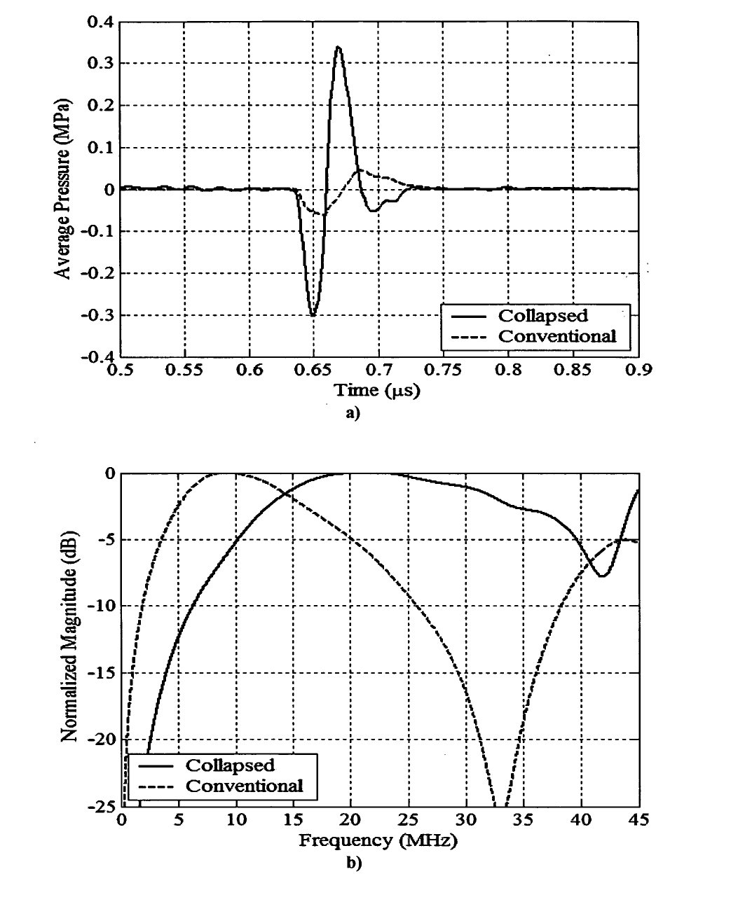

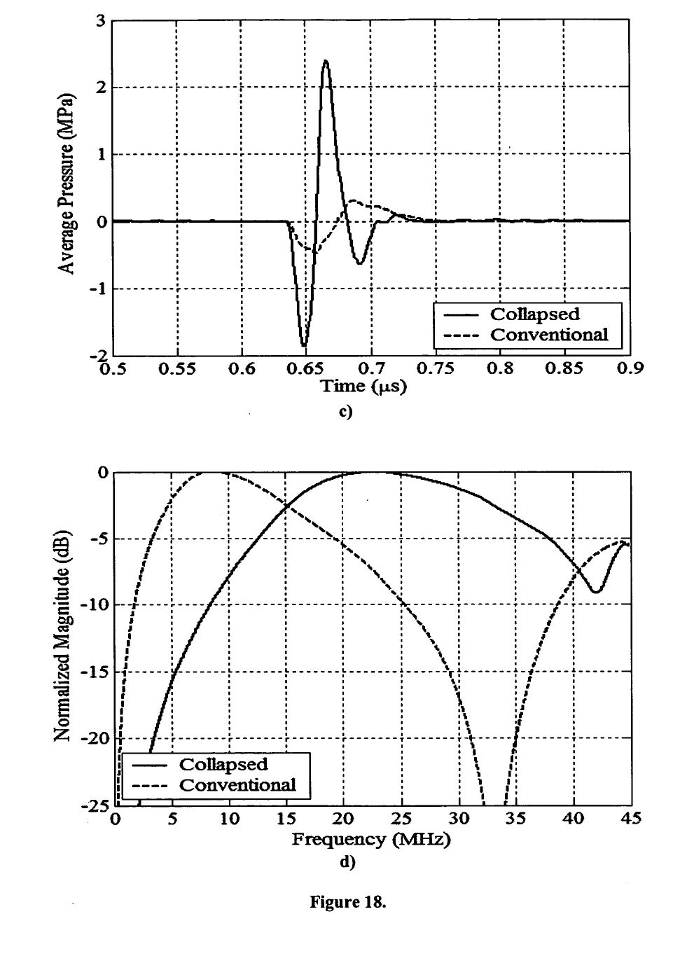

The cMUT with the physical dimensions given in Table I provided higher coupling efficiency (k_{T}²) in the collapsed operation between the collapse (96 V) and snapback (70 V) voltages, when compared with that in the conventional operation (FIG. 17(b)). At a bias voltage of 83 V (86% of the collapse voltage), the coupling efficiency in the collapsed and conventional operations was 0.36 and 0.17, respectively. The cMUT was biased at this voltage in both operation regimes and +5 V rectangular pulse was applied for tP=20 ns at t=0.6 μs. The 500 μm thick substrate was assumed to be backed with an impedance-matched material in this calculation. The acoustic output pressure was averaged over the plane 60 μm away from the cMUT surface and is depicted in FIG. 18(a). The peak-to-peak pressures in the collapsed and conventional operation regimes were 641 kPa (128 kPa/V) and 107 kPa (21 kPa/V), respectively. Therefore, the collapsed operation generated six times greater acoustic output pressure at the same bias voltage (83 V) for small pulse excitations (+5 V pulse). The frequency spectrum of the average acoustic pressure, divided by that of the pulse, is depicted in FIG. 18(b). The conventional operation had a center frequency of 9.2 MHz, with a fractional bandwidth of 130%. Also, a dip larger than −25 dB in the frequency spectrum was observed at the anti-resonance frequency of 33 MHz. The collapsed operation was centered at 21.6 MHz, with a fractional bandwidth of 108%. A dip of −7 dB in the frequency spectrum was observed at the frequency of 42 MHz, which corresponded to the inverse of the cell periodicity time of flight of the acoustic wave calculated with f_{CELL}=v_{FLUID}/C, where v_{FLUID} is the velocity of sound in the acoustic medium and C is the cell periodicity, given in Table I and shown in FIG. 16. This analysis of the small pulse excitation (+5 V) of a biased cMUT (86% of the collapse voltage) was extended to the large pulse excitation (+30 V) of the cMUT for t_{P}=20 ns, keeping the bias voltage the same for both operation regimes. The average acoustic pressure is shown in FIG. 18(c). The peak-to-peak pressures in the collapsed and conventional operation regimes were 4.26 MPa (142 kPa/V) and 0.77 MPa (25.6 kPa/V), respectively. The frequency spectrum of the average acoustic pressure was divided by that of the pulse (FIG. 18(d)). The conventional operation had a center frequency of 8.6 MHz, with a fractional bandwidth of 132%. The collapsed operation was centered at 22.7 MHz, with a fractional bandwidth of 84%. In the extraction of the frequency spectrum in the collapsed operation regime, a shorter pulse (t_{P}=10 ns) was used, since the 3-dB bandwidth could not be determined from the t_{P}=20 ns pulse excitation.

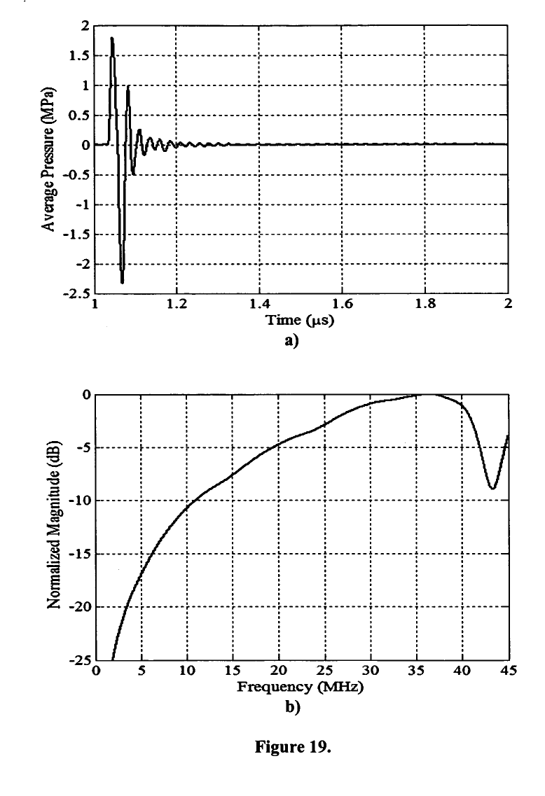

The cMUT was biased at 120 V (125% of the collapse voltage) in the collapsed operation regime. A −30 V rectangular pulse was applied for t_{P}=20 ns at t=1 μs. The average output pressure is shown as a function of time in FIG. 19(a). The peak-to-peak pressure of 4.1 MPa was calculated, yielding 136.6 kPa/V acoustic output pressure per volt. The frequency spectrum of the average acoustic pressure was divided by that of the pulse (FIG. 19(b)). The collapsed operation was centered at 34 MHz. The collapsed operation at the bias voltage of 120 V resulted in a 50% increase in the center frequency over the same operation regime at the bias voltage of 83 V (f0=34 MHz at VBIAS=120 V, f₀=22.7 MHz at V_{BIAS}=83 V, both in collapsed operation regime). A dip of −7 dB in the frequency spectrum (FIG. 18(b)) is also seen in FIG. 19(b) at the same frequency of 42 MHz, due to cell periodicity (C).

The results of conventional and collapsed operations shown in FIGS. 18(a)-(d) are compared. The important finding is the generation of six times larger acoustic output pressure in the collapsed operation, compared to the conventional operation, at the same bias voltage. The center frequency of the collapsed operation was approximately twice as large as the center frequency in the conventional operation, when the bias voltage was set between the collapse and snapback voltages. The center frequency of 9.2 MHz in the conventional operation became 21.6 MHz in the collapsed operation, both biased at 83 V. When the bias voltage in the collapsed operation was increased to 120 V (125% of the collapse voltage), the center frequency increased to 34 MHz. This frequency was 150% and 370% of the center frequencies in the collapsed and conventional operation regimes at 83 V, respectively. Therefore, collapsed operation provided frequency tunability over a large range, up to almost 4 times of the center frequency in the conventional regime, by biasing the cMUT only at 125% of the collapse voltage. Alternatively, keeping the center frequency the same, the operating voltages could be reduced by utilizing the collapsed operation.

The dip observed due to anti-resonance frequency at 33 MHz in conventional operation, was also avoided in the collapsed operation (FIGS. 18(b,d)). However, the presence of the dip, due to cell periodicity, suggested that the cell periodicity (C) should be reduced accordingly in the high frequency cMUT designs.

Although specific membrane, support and substrate materials and specific methods of fabrication have been described the present invention is applicable to devices fabricated with any material and any technology (surface or bulk micromachining and wafer bonding).

In summary, the collapsed operation offered over 100% fractional bandwidth with 6 times larger acoustic output pressure (compared to the conventional operation at the same bias voltage) at approximately twice the center frequency of the conventional operation. The center frequency of the collapsed operation was increased from 22 MHz to 34 MHz without any degradation in the acoustic output pressure when the bias voltage was changed from 83 V to 120 V. The collapsed operation was beneficial for the high frequency cMUT applications. The cell periodicity (C) became an important factor due to the loading of the cMUT cells, all driven in parallel, at the frequency f_{CELL}, suggesting the scaling of the cell periodicity accordingly in high frequency cMUTs.

### REFERENCES

1. A. S. Ergun, B. Temelkuran, E. Ozbay, and A. Atalar, “A New Detection Method for Capacitive Micromachined Ultrasonic Transducers,” IEEE Trans. on UFFC, Vol. 48, No. 4, pp. 932-942, July 2001.
2. F. V. Hunt, Electroacoustics; the analysis of transduction, and its historical background, Cambridge, Harvard University Press, 1954.
3. O. Oralkan, X. Jin, F. L. Degertekin, and B. T. Khuri-Yakub, “Simulation and Experimental Characterization of a 2-D Capacitive Micromachined Ultrasonic Transducer Array Element,” IEEE Trans. on UFFC, Vol. 46, No. 6, pp. 1337-1340, November 1999.
4. Y. Roh, and B. T. Khuri-Yakub, “Finite Element Analysis of Underwater Capacitor Micromachined Ultrasonic Transducers,” IEEE Trans. on UFFC, Vol. 49, No. 3, pp. 293-298, March 2002.
5. ANSYS 5.7, Ansys Inc., Southpointe, 275 Technology Drive, Canonsburg, Pa. 15301.
6. J. Fraser, and P. Reynolds, “Finite-Element Method for Determination of Electromechanical Coupling Coefficient for Piezoelectric and Capacitive Micromachined Ultrasonic transducers”, Joint 140th meeting of ASA/NOISE-CON, 2000.
7. D. Belincourt, “Piezoelectric crystals and ceramics” in Ultrasonic Transducer Materials, edited by O. E. Mattiat, Plenum Press, New York-London, 1971.
8. ANSYS 7.1, Ansys Inc., Southpointe, 275 Technology Drive, Canonsburg, Pa. 15301.
9. M. J. Grote, “Nonreflecting Boundary Conditions for Time Dependent Wave Propagation”, M. J. Grote, Artificial Boundary Conditions with Applications to Computational Fluid Dynamics, Ed. L. Tourrette, Nova Science Publishers Inc., New York, 2001.
10. LS-DYNA 970, Livermore Software Technology Corporation, Livermore, Calif. 94551.
11. B. Bayram, E. Hæggström, G. G. Yaralioglu, and B. T. Khuri-Yakub, “A New Regime for Operating Capacitive Micromachined Ultrasonic Transducers,” IEEE Trans. on UFFC, Vol. 50, No. 9, pp. 1184-1190, September 2003.
12. Y. Huang, B. Bayram, A. S. Ergun, E. Hæggström, C. H. Cheng, and B. T. Khuri-Yakub, “Collapsed Region Operation of Capacitive Micromachined Ultrasonic Transducers based on Wafer-bonding Technique,” in Proceedings of IEEE Ultrasonics Symposium, Vol. 2, pp. 1161-1164, 2003.

1. The method of operating a capacitive membrane ultrasonic transducer which comprises the steps of:
determining the amplitude of the collapse and snapback voltages;
applying a voltage greater than the collapse voltage to the transducer to cause the membrane to collapse;
thereafter applying a DC bias voltage having an amplitude which is greater than the snapback voltage so that the membrane is still collapsed; and
operating the capacitive membrane ultrasonic transducer in the transmit or receive mode while the membrane is collapsed.

2. The method of claim 1 in which a drive voltage is applied to the bias voltage while the membrane is collapsed to operate the membrane ultrasonic transducer in the transmit mode.

3. The method as in claim 2 in which the drive voltage is a voltage pulse.

4. The method of claim 2 in which the drive voltage is an AC voltage.

5. The method of claims 2, 3 or 4 in which the amplitude of the drive voltage has an amplitude such that the sum of the bias voltage and the applied drive voltage is more than the snapback voltage to ensure operation in the collapsed state.

6. The method of claim 5 wherein the bias voltage is selected to operate the transducer at a selected frequency.

7. The method of claims 1 or 5 in which the drive voltage is a negative or positive pulse.

8. The method of claim 1 in which the membrane motion is induced by received ultrasonic energy and the transducer generates an output electrical signal representative of the received ultrasonic emery.

9. An ultrasonic system comprising:
a transducer having a membrane supported spaced from a substrate by and insulating support with electrodes on said membrane and support, said membrane responding to a collapse voltage to collapse against the substrate and to a snapback voltage to resume its spaced position;
a voltage source for applying a voltage to said membrane which causes it to collapse and thereafter applying a bias voltage which is larger than the snapback voltage; and
means for applying a drive voltage between said electrodes which has an amplitude such that the sum of the bias voltage and the applied drive voltage is more than the snapback voltage to insure operation of the transducer with the membrane in the collapsed state.

10. An ultrasonic system as in claim 9 in which the membrane is silicon.

11. An ultrasonic system as in claim 9 in which the membrane is silicon nitride.

12. An ultrasonic system as in claims 10 or 11 in which the support is silicon and insulating support is silicon oxide.

13. An ultrasonic system as in claim 12 in which the transducer if fabricated by micromachining.

14. An ultrasonic system as in claim 8 in which the transducers is a cMUT.
